(19) United States
(12) Patent Application Publication
(10) Pub. No.: US 2026/0014926 A1
(43) Pub. Date: Jan. 15, 2026

(54) Ratchet Strap Handle Extension Device

(71) Applicant: Gary Wildt, Montello, WI (US)

(72) Inventor: Gary Wildt, Montello, WI (US)

(21) Appl. No.: 19/233,295

(22) Filed: Jun. 10, 2025

Related U.S. Application Data
(60) Provisional application No. 63/668,796, filed on Jul. 9, 2024.

(51) Int. Cl. B60P 7/08

(52) U.S. Cl. CPC B60P 7/0853; B60P 7/083

(57) ABSTRACT

A ratchet strap handle extension device is provided. The device is comprised of a housing dimensioned to interface with conventional ratchet strap handles. The housing comprises an insertion opening that allows a ratchet strap handle to be inserted into an interior space. The interior space may comprise at least one receiving area, which may include grooves, recesses, or cavities that stabilize the handle within the housing. The device may also be comprised of retention mechanisms to prevent axial or lateral displacement of the handle during use. The device may also further comprise a securing interface which may include snap-fit tabs or fastening straps to provide additional stabilization. Attached to the housing is at least one handle that serves as the primary user interface and may be integrally formed or pivotally connected via a pivot point allowing rotation between storage and operational states.

### CROSS-REFERENCE TO RELATED APPLICATION

The present application claims priority to, and the benefit of, U.S. Provisional Application No. 63/668,796, which was filed on Jul. 9, 2024, and is incorporated herein by reference in its entirety.

### FIELD OF THE INVENTION

The present invention relates generally to the field of ratchet straps. More specifically, the present invention relates to a device that can receive a handle of a ratchet strap assembly such that the device can be used to operate the handle to increase mechanical leverage and usability. Accordingly, the present disclosure makes specific reference thereto. Nonetheless, it is to be appreciated that aspects of the present invention are also equally applicable to other like applications, devices, and methods of manufacture.

### BACKGROUND

Securing cargo using ratchet straps is a common method employed across transportation, logistics, and personal moving scenarios. However, effective tensioning of ratchet straps often requires considerable manual force, posing a significant challenge for users with limited upper body mobility or reduced physical strength. This limitation can result in improperly secured loads, increasing the risk of cargo shifting or dislodging during transport. Improper tightening not only compromises safety but may also lead to loss or damage of equipment, goods, or vehicles. Traditional ratchet mechanisms typically provide minimal mechanical leverage and require repetitive motion to achieve sufficient strap tension. These limitations create inefficiencies in both commercial and personal applications where quick, secure, and repeatable fastening is necessary. Users may also experience fatigue or injury due to awkward positioning or insufficient grip support, further complicating the ratcheting process. In many use cases, accessibility and speed are equally critical, particularly when time-sensitive or high-volume operations are involved.

Therefore, there exists a long-felt need in the art for a ratchet strap handle extension device that enables users to apply greater tension to ratchet straps with reduced physical effort. There also exists a long-felt need in the art for a ratchet strap handle extension device that provides secure and reliable engagement with existing ratchet strap handles to prevent loosening during transport. Moreover, there exists a long-felt need in the art for a ratchet strap handle extension device that simplifies the ratcheting process for users with limited strength or mobility.

The subject matter disclosed and claimed herein, in one embodiment thereof, comprises a ratchet strap handle extension device. The device is comprised of a housing dimensioned to interface with conventional ratchet strap handles. The housing comprises an insertion opening that allows a ratchet strap handle to be inserted into an interior space configured to accommodate a variety of handle shapes and sizes. The interior space may comprise at least one receiving area, which may include grooves, recesses, or cavities that stabilize the handle within the housing. The device may also be comprised of retention mechanisms to prevent axial or lateral displacement of the handle during use. The device may also further comprise a securing interface which may include snap-fit tabs or fastening straps to provide additional stabilization. Attached to the housing is at least one handle that serves as the primary user interface and may be integrally formed or pivotally connected via a pivot point allowing rotation between storage and operational states. The handle comprises at least one grip area that may be comprised of non-slip materials and textured surfaces to improve manual control under various conditions. Additionally, the housing may comprise at least one access cutout configured to permit unobstructed access to a release mechanism on the original ratchet strap handle while using the device.

In this manner, the ratchet strap handle extension device of the present invention accomplishes all the forgoing objectives and provides a device that increases mechanical leverage of an existing ratchet strap handle, thereby reducing the physical force required during ratcheting. The retention mechanisms and securing interface ensure stable attachment to a variety of ratchet handle types, thereby mitigating the risk of disengagement or slippage under load. The grip areas and optional rotational handle configuration support a broad range of users, including those with limited mobility, and allow the ratcheting operation to be conducted with greater safety and efficiency. These features collectively address the longstanding issues of usability, safety, and effectiveness in load-securing applications using existing ratchet strap assemblies.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a ratchet strap handle extension device is designed to improve the performance and usability of conventional ratchet strap systems by enabling enhanced tensioning, reduced manual effort, and increased versatility in load-securing applications.

The device is comprised of a housing dimensioned to fully or partially envelop a ratchet strap handle, providing a mechanical interface between the housing and the handle. The housing is comprised of an insertion opening that permits introduction of the handle into an interior space. The interior space may be comprised of at least one receiving area located on any interior surface of the housing in one embodiment. The receiving area is configured to receive part or all of the handle and may include grooves, channels, recesses, or cavities oriented axially or transversely to stabilize the handle. Retention mechanisms may also be included to prevent axial or lateral displacement of the handle once inserted into the interior space.

The housing is further comprised of at least one handle that provides a leverage interface. The handle may be integrally formed with the housing or mechanically attached via a pivot point that allows the handle to rotate or fold between storage and deployed states. In this embodiment, a locking mechanism further locks the handle in either state. The handle is further comprised of at least one grip arca. The grip area may be contoured to fit a hand and may be made from non-slip materials. The grip area may also include a grip texture to enhance tactile engagement.

The present invention is also comprised of a method of using the device that includes providing the device comprising a housing with an insertion opening, an interior space, and at least one handle. A ratchet strap handle is inserted into the interior space through the insertion opening and positioned within the receiving area, where it is retained by at least one retention mechanism, if present. If also present, a securing interface is engaged to further stabilize the handle. The user deploys the handle by rotating it about the pivot point and locking it into position. The grip area is then grasped by the user and used to move the handle in a back-and-forth motion to tighten the ratchet strap with increased leverage by moving the handle of the ratchet strap assembly.

Accordingly, the ratchet strap handle extension device of the present invention is particularly advantageous as it provides a device that increases mechanical leverage of an existing ratchet strap handle, thereby reducing the physical force required during ratcheting. The retention mechanisms and securing interface ensure stable attachment to a variety of ratchet handle types, thereby mitigating the risk of disengagement or slippage under load. The grip areas and optional rotational handle configuration support a broad range of users, including those with limited mobility, and allow the ratcheting operation to be conducted with greater safety and efficiency. These features collectively address the longstanding issues of usability, safety, and effectiveness in load-securing applications using existing ratchet strap assemblies. In this manner, the ratchet strap handle extension device overcomes the limitations of existing ratchet strap assemblies known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a ratchet strap handle extension device of the present invention in accordance with the disclosed architecture;

FIG. 2 illustrates a perspective view of one potential embodiment of a ratchet strap handle extension device of the present invention while a ratchet handle is inserted within the housing in accordance with the disclosed architecture;

FIG. 3 illustrates a perspective view of one potential embodiment of a ratchet strap handle extension device of the present invention while a ratchet handle is inserted within the housing while a user is grasping the handle to move the ratchet handle in accordance with the disclosed architecture; and

FIG. 4 illustrates a flowchart of a method of using one potential embodiment of a ratchet strap handle extension device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a ratchet strap handle extension device that enables users to apply greater tension to ratchet straps with reduced physical effort. There also exists a long-felt need in the art for a ratchet strap handle extension device that provides secure and reliable engagement with existing ratchet strap handles to prevent loosening during transport. Moreover, there exists a long-felt need in the art for a ratchet strap handle extension device that simplifies the ratcheting process for users with limited strength or mobility.

The present invention, in one exemplary embodiment, is comprised of a ratchet strap handle extension device. The device is designed to improve the performance and usability of traditional ratchet strap systems by allowing for enhanced tensioning, minimized manual effort, and greater versatility across load-securing scenarios. The device is comprised of a housing that is shaped to fully or partially enclose a ratchet strap handle, thereby establishing a mechanical interface between the housing and the handle. The housing includes an insertion opening configured to allow the handle to be introduced into an interior space. In one embodiment, the interior space includes at least one receiving area positioned on any interior surface of the housing. The receiving area is configured to accommodate a portion or the entirety of the handle and may feature grooves, channels, recesses, or cavities that are axially or transversely oriented to stabilize the handle. In one embodiment, retention mechanisms may also be incorporated to inhibit axial or lateral movement of the handle within the interior space.

The housing further incorporates at least one handle configured to function as a leverage interface for the user. The handle may be integrally formed with the housing or mechanically connected by a pivot point, which permits the handle to rotate or fold between a stored and an operational position. A locking mechanism is included in this configuration to secure the handle in either position. The handle is further comprised of at least one grip area, which may be contoured to accommodate the human hand and constructed from non-slip materials. Additionally, the grip area may be enhanced with grip textures to improve tactile control.

The invention also includes a method of use in which the device is provided with a housing that includes an insertion opening, an interior space, and at least one handle. A ratchet strap handle is inserted through the insertion opening into the interior space and positioned in the receiving area, where retention mechanisms, if present, secure it in place. If a securing interface is included, said interface is engaged to further stabilize the handle. The handle is then rotated into a deployed state via the pivot point and locked using the locking mechanism. The user then grips the grip area and moves the handle in a reciprocating motion, thereby tightening the ratchet strap with enhanced leverage by actuating the underlying ratchet strap handle.

As a result, the ratchet strap handle extension device offers significant advantages by increasing the mechanical leverage applied to an existing ratchet strap handle, thereby decreasing the physical force required for operation. The inclusion of retention mechanisms and a securing interface ensures a stable connection to various ratchet handle types, reducing the likelihood of slippage or disengagement during load-securing tasks. The grip areas and optional rotational handle design accommodate users with limited mobility and enable safer, more efficient ratcheting. These combined features address long-standing challenges related to usability, safety, and effectiveness in traditional ratchet strap assemblies, offering a substantial improvement over existing solutions.

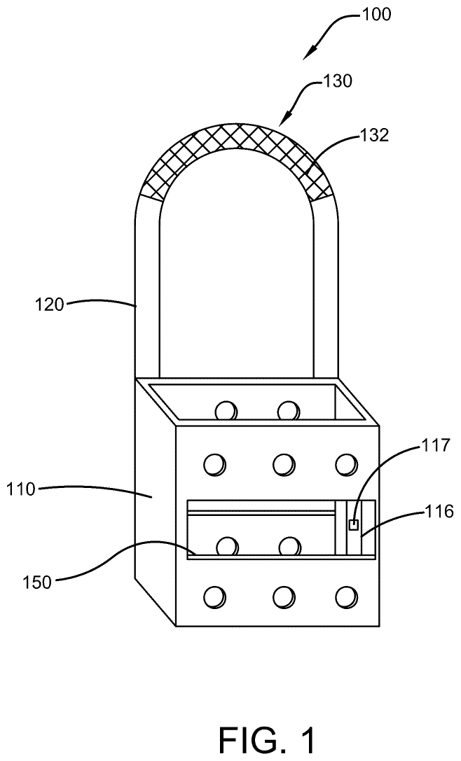

Referring initially to the drawings, FIG. 1 illustrates a perspective view of one potential embodiment of a ratchet strap handle extension device 100 of the present invention in accordance with the disclosed architecture. The device 100 is designed to enhance the performance and usability of conventional ratchet strap systems typically employed for securing loads. More specifically, the device 100 may facilitate improved tensioning, reduced manual effort, and increased versatility across various load-securing scenarios.

The device 100 is comprised of a housing 110. The housing 110 may be manufactured from materials such as but not limited to polymer composites, metal alloys (e.g., aluminum, stainless steel, etc.), reinforced plastics, high-density polyethylene, impact-resistant thermoplastics, etc.

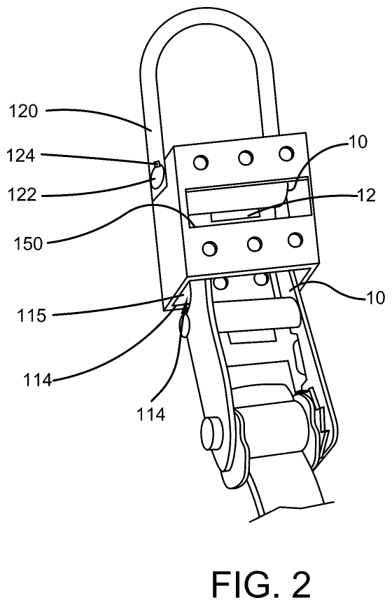

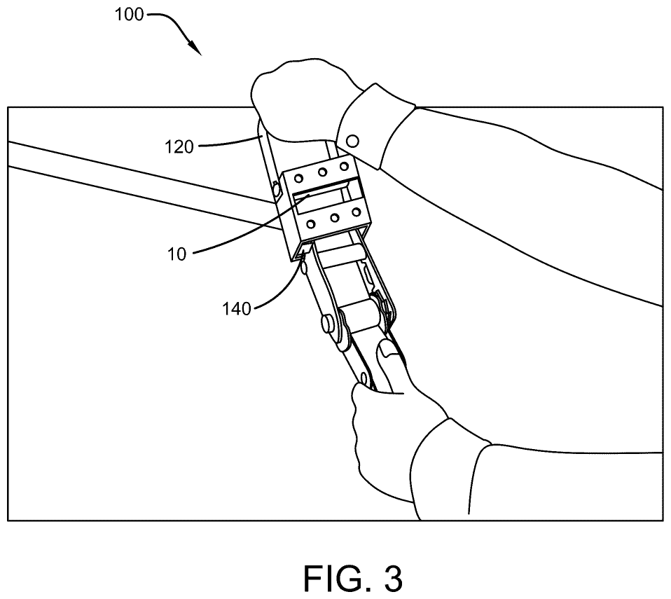

The housing 110 may be dimensioned to fully or partially envelop a ratchet strap handle 10 as seen in FIG. 2 and FIG. 3, thereby enabling mechanical interfacing between the housing 110 and the handle 10. As a result, the housing 110 may be any shape in different embodiments. The housing 110 may be comprised of an insertion opening 112 configured to permit introduction of the handle 10 into an interior space 114 of the housing 110. The interior space 114 may be shaped to accommodate ratchet handles of varying sizes, profiles, and forms, including open-grip and closed-grip configurations.

In one embodiment, the interior space 114 is comprised of at least one receiving arca 116 that may be located anywhere in the interior space 114 including on any interior surface 115 of the housing 110., as seen in FIG. 1 The receiving area 116 may be configured to receive the entirety or a portion of the handle 10. The receiving area 116 may be but is not limited to grooves, channels, recesses, or cavities that may be oriented axially or transversely to stabilize the handle 10 within the housing 110. The receiving area 116 (and/or any other area of the device 100) may be further comprised of retention mechanisms 117, such as but not limited to internal ribs, elastomeric pads, spring-loaded clamps, or hook-and-loop fasteners to prevent axial or lateral displacement of the handle 10 from the housing 110 during use. In one embodiment, the handle 10 may be further retained via a securing interface 140 that may be positioned on the exterior of the housing 110 and/or within the interior space 114. The interface 140 may include passive or active engagement features such as but not limited to snap-fit tabs, compression pads, or fastening straps, etc.

The housing 110 may be further comprised of at least one handle 120. The handle 120 may serve as the primary leverage interface for the user during use of the device 100. In one embodiment, the handle 120 may be integrally formed with the housing 110. In another embodiment, the handle 120 may be mechanically attached to the housing 110 via at least one pivot point 122, as seen in FIG. 2. The pivot point 122 may be comprised of but is not limited to hinge pins, torsional joints, socket-and-arm connections, universal joints, hinges, etc. The pivot point 122 may allow the handle 120 to rotate or fold along a predefined axis to transition between a storage state and a deployed operational state. The handle 120 may be locked in a folded or unfolded state via at least one locking mechanism 124. The locking mechanism 124 may be comprised of but is not limited to spring-biased latches, over-center locks, ratcheting detents, sliding pins, magnetic locks, cam-action brackets, etc.

The handle 120 may be further comprised of at least one grip area 130, as seen in FIG. 1. The grip area 130 may be a contoured grip area designed to fit the human hand in one embodiment. In some embodiments, the grip area 130 may be comprised of non-slip materials such as but not limited to thermoplastic elastomers, nitrile rubber, silicone coatings, or textured overmolds. The grip area 130 may further be comprised of a grip texture 132 such as but not limited to knurling, cross-hatching, stippling, raised ridges, molded patterns, etc. to improve tactile engagement under wet or greasy conditions.

In an additional embodiment, the housing 110 may be comprised of at least one access cutout 150, as seen in FIG. 1. The access cutout 150 may be strategically located and dimensioned to provide unimpeded access to an existing release mechanism 12 on the ratchet strap handle 10.

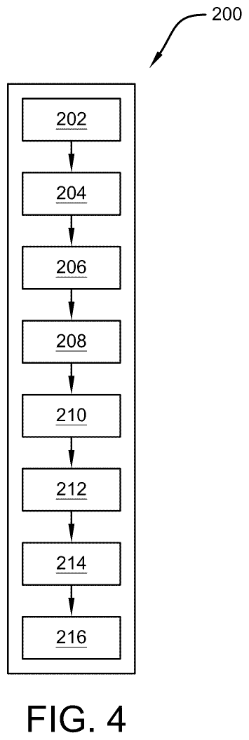

The present invention is also comprised of a method of using 200 the device 100, as seen in FIG. 4. First, a device 100 is provided may be comprised of a housing 110 comprised of an insertion opening 112, an interior space 114, and at least one handle 120, or have any other features or combination thereof as mentioned supra [Step 202]. Then, a ratchet strap handle 10 is inserted through the insertion opening 112 and into the interior space 114 of the housing 110 [Step 204]. Next, the handle 10 is positioned within the receiving area 116 such that the handle 10 is retained by at least one retention mechanism 117 to prevent displacement during use (in an embodiment of the device 100 with a receiving area 116) [Step 206]. In an embodiment of the device 100 with a securing interface 140, the interface 140 is then engaged to further stabilize the handle 10 within the housing 110 [Step 208]. In an embodiment where the handle 120 is rotatable, the handle 120 is then transitioned from a storage state to a deployed operational state by rotating it about the pivot point 122 [Step 210]. Once deployed, the handle 120 is locked into position via the locking mechanism 124 to provide a stable leverage interface for the user [Step 212]. The user then grasps the grip area 130 of the handle 120 (as seen in FIG. 3) and moves the handle 120 in a back-and-forth motion to tighten the ratchet strap assembly by moving the handle 10 with improved leverage [Step 214]. The access cutout 150 may further allow the user to actuate the release mechanism 12 of the ratchet strap handle 10 as needed without obstruction [Step 216].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “ratchet strap handle extension device” and “device” are interchangeable and refer to the ratchet strap handle extension device 100 of the present invention.

Notwithstanding the forgoing, the ratchet strap handle extension device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the ratchet strap handle extension device 100 as shown in the FIGS. are for illustrative purposes only, and that many other sizes and shapes of the ratchet strap handle extension device 100 are well within the scope of the present disclosure. Although the dimensions of the ratchet strap handle extension device 100 are important design parameters for user convenience, the ratchet strap handle extension device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A ratchet strap handle extension device comprising:
a housing comprising an opening and an interior space; and
a handle attached to the housing, the handle comprised of a grip area.

2. The ratchet strap handle extension device of claim 1, wherein the handle is attached to the housing via a pivot point.

3. The ratchet strap handle extension device of claim 2 further comprised of a locking mechanism.

4. The ratchet strap handle extension device of claim 1, wherein the housing is comprised of a cutout.

5. The ratchet strap handle extension device of claim 1 wherein the housing is comprised of a securing interface.

6. The ratchet strap handle extension device of claim 5, wherein the securing interface is comprised of a snap-fit tab, a compression pad, or a fastening strap.

7. A ratchet strap handle extension device comprising:
a housing comprising:
an opening;
an interior space comprised of a receiving area;
a handle attached to the housing, the handle comprised of a grip area.

8. The ratchet strap handle extension device of claim 7, wherein the handle is attached to the housing via a pivot point.

9. The ratchet strap handle extension device of claim 7 further comprised of a locking mechanism.

10. The ratchet strap handle extension device of claim 7, wherein the receiving area is a comprised of a groove, a channel, a recess, or a cavity.

11. The ratchet strap handle extension device of claim 7, wherein the housing is comprised of a cutout.

12. The ratchet strap handle extension device of claim 7, wherein the receiving area is further comprised of a retention mechanism.

13. The ratchet strap handle extension device of claim 12, wherein the retention mechanism is comprised of an internal rib, an elastomeric pad, a spring-loaded clamp, or a hook and loop fastener.

14. The ratchet strap handle extension device of claim 7, wherein the housing is comprised of a securing interface.

15. The ratchet strap handle extension device of claim 14, wherein the securing interface is comprised of a snap-fit tab, a compression pad, or a fastening strap.

16. The ratchet strap handle extension device of claim 7, wherein the grip area is comprised of a contoured shape.

17. The ratchet strap handle extension device of claim 7, wherein the grip area is comprised of a thermoplastic elastomer, a nitrile rubber, a silicone coating, or a textured overmold.

18. The ratchet strap handle extension device of claim 7, wherein the grip area is comprised of a texture.

19. The ratchet strap handle extension device of claim 18, wherein the texture is comprised of a knurling, a cross-hatching, a stippling, a raised ridge, or a molded pattern.

20. A method of using a ratchet strap handle extension device, the method comprising the following steps:
providing a ratchet strap handle extension device comprised of a housing, the housing comprising an insertion opening, an interior space, and a handle;
inserting a ratchet strap handle through the insertion opening into the interior space of the housing; and
grasping the handle and moving the handle in a back-and-forth motion to tighten the ratchet strap assembly via moving the ratchet strap handle.
